(19) United States
(12) Patent Application Publication
(10) Pub. No.: US 2002/0091605 A1
(43) Pub. Date: Jul. 11, 2002

(54) Asset allocation optimizer

(76) Inventors: Russell Paul Labe JR., Belle Mead, NJ (US); Je Hyung Oh, Princeton, NJ (US)

Correspondence Address: WHITE & CASE LLP, PATENT DEPARTMENT, 1155 AVENUE OF THE AMERICAS, NEW YORK, NY, 10036, US

(21) Appl. No.: 09/741,561

(22) Filed: Dec. 20, 2000

Related U.S. Application Data
(60) Provisional application No. 60/244,999, filed on Nov. 1, 2000.

(51) Int. Cl. G06F 17/60

(52) U.S. Cl. 705/36

(57) ABSTRACT

The present invention provides a method and system for electronically generating over a network a set of optimal and near-optimal portfolios in which the number of assets in the portfolio is limited by an integer constraint. Recommended optimal or near-optimal portfolios are based on the user's investment profile comprising features such as the user's risk and expected return tolerance. Portfolios which are less desirable than recommended portfolios and which are still within the user's investment profile may be displayed as a set of alternative portfolios. Optimal portfolios are obtained using a mixed-integer nonlinear programming approach in conjunction with an integer constraint on the number of assets in a portfolio. Near-optimal portfolios are identified through the application of a genetics algorithm on a set of optimal allocations. Asset class factors are utilized in the analysis to provide stability in the results and to include a wider range of historic market and asset conditions.

This application claims the benefit of U.S. Provisional Application serial number 60/244,999, filed Nov. 1, 2000.

### FIELD OF THE INVENTION

The present invention relates to the field of investment services. More particularly, the present invention describes a method and system for generating an optimal or near-optimal portfolio of assets where the total number of assets corresponds to an integer constraint.

### BACKGROUND OF THE INVENTION

Investors typically want to increase the returns of their financial portfolios without taking on significant additional risk. Portfolio analysis is a useful technique for analyzing the returns of a portfolio of assets. In portfolio analysis, an optimal allocation of assets, that is, the highest-yielding allocation of assets for a given level of risk for a particular investor, is identified from the universe of assets available.

Mean-variance optimization, originally developed by Harry Markowitz, is a particularly widespread model used to identify optimal allocations of assets and is well-known in the art. According to this model, there is a set of portfolios which provides the lowest level of risk for each level of return, and the highest level of return for each level of risk. By considering all combinations of assets, a special set of portfolios is derived. This special set is known as an “efficient frontier”, and identifies a highest-yielding and optimal portfolio for a given risk level for a particular combination of securities. Virtually every major money manager today uses some type of electronic optimization program to evaluate basic portfolio risk and return trade-offs.

Although holding an optimal portfolio may be advantageous and desirable, there are several concerns that may limit the effectiveness of holding an optimal allocation of assets. If there is a substantial difference in holdings between the portfolio currently held by an investor and an optimal portfolio, significant rebalancing will be required. The costs associated with the sale of undesired assets currently held, and the purchase of new assets for the optimal portfolio, may dissipate any advantages that may accrue from adopting an optimal portfolio.

Some individuals may already own one or more assets and wish to retain these particular assets in their portfolios as part of an optimization. By retaining some or most of these prior holdings, the investor can advantageously expect to reduce sales charges associated with portfolio rebalancing, even if a less-than-ideal portfolio is obtained.

If an investor is uncomfortable with a recommended optimal portfolio, he or she will not be likely to adopt that portfolio. For example, investors are not likely to adopt optimal portfolios when the number of recommended assets is subjectively too high or too low. If a portfolio includes a large number of assets, each of which comprises only a small percentage of the total, then the costs of administering and attending to these relatively small asset allocations in an optimal portfolio may not prove to be beneficial to the investor.

Some investors may also discover there may be only small differences between the risk and return levels of an optimum portfolio and a nearly optimal portfolio. These individuals may not wish to completely rebalance their portfolios by selling all their assets and purchasing entirely different holdings, if they feel a new asset allocation will not increase returns sufficiently to justify a complete portfolio rebalance.

Additionally, optimal portfolios are usually optimal for a short period of time. Because interest rates, asset valuations, and financial markets are constantly in flux, an optimal portfolio may quickly be rendered non-optimal. For an investor to retain an optimal portfolio, frequent rebalancing will be required, with the potential for diminishing the overall returns via brokerage fees and other service charges.

Many users favor having a portfolio with a reduced number of assets, over a larger portfolio comprising a greater number of assets. By including fewer assets in a portfolio, the user would tend to reduce the amount of time and effort necessary to monitor the performance of the portfolio and its component assets. Certain individuals may prefer a particular number of assets in their portfolios and wish to specify that their portfolios should contain, for example, only five or seven assets. Conventional optimization methods do not have the ability for the user or service provider to constrain the portfolio optimization to include only a given number of assets.

The prior art considers that an “optimal” portfolio of assets is the most desirable allocation of assets. The present invention recognizes that an optimal portfolio may not be the best investment vehicle for every investor in every situation, and that there will be circumstances in which individuals will prefer a nearly optimal allocation of assets instead of an optimal allocation.

These and other shortcomings of the prior art are solved by the present invention, which provides a method and system for enhancing the performance of a user's portfolio in accordance with the user's investment goals. Using the invention, an investor has the opportunity to identify optimal and near-optimal portfolios which contain a specific number of assets and to tailor such portfolios to the investor's preferences. Users have the flexibility to display concurrently any one or more optimal or near-optimal portfolios generated using this invention.

In this invention, the terms “near-optimal portfolio” and “near-optimal allocation of assets” are to be understood as meaning a portfolio or set of assets that is not an optimal set of assets for an investor, and yet is within user-acceptable tolerance of an optimal allocation, as further described in the specification below. “Optimization”, unless further qualified, is to be understood to mean collectively the generation of optimal and near-optimal portfolios using the process described in this invention. A “non-optimal” portfolio is a portfolio which is not optimal, but which may be near-optimal in accordance with the method of this invention.

### SUMMARY OF THE INVENTION

The present invention provides a method and system for generating optimal and near-optimal financial portfolios which contain a specific number of assets.

Optimal and near-optimal allocations of assets are obtained in accordance with the invention by using a novel mixed-integer nonlinear programming approach in conjunction with the constraint that allocations only contain the number of assets corresponding to an integer constraint. Near-optimal allocations are also found by employing a genetics algorithm on a previously-identified optimal allocation. Asset class factors are utilized in the analysis to provide stability in the results and to include a wider range of historic market and asset conditions.

The present invention provides a method for using an electronic network to generate an optimal allocation of assets using factor analysis, while providing the user with the opportunity to enter a constraint on the number of assets in the portfolio. Additionally, the invention provides for a method of using an electronic network to identify suitable near-optimal portfolios for a user by the application of a genetics algorithm on an optimal portfolio.

Specifically, according to one embodiment of the invention, a method is provided for electronically generating over a network a set of near-optimal allocations of assets for a portfolio. The method comprises obtaining a user's investment profile, obtaining a set of optimal allocations of assets using portfolio optimization, and generating a set of near-optimal allocations of assets derived from the optimal allocations by a genetics algorithm. The near-optimal allocations reflect the user's investment profile.

According to a second embodiment of the invention, a method is provided for electronically generating over a network a set of near-optimal allocations of assets for a portfolio. The method comprises obtaining a user's investment profile and obtaining an integer constraint on the total number of assets to include in the portfolio. A set of optimal allocations of assets is obtained using portfolio optimization, wherein the optimal allocations reflect the user's investment profile. A set of near-optimal portfolios derived from the set of optimal allocations is generated by a genetics algorithm. The near-optimal portfolios reflect the user's investment profile and contain the total number of assets limited by the integer constraint.

According to a third embodiment of the invention, a method is provided for electronically generating over a network a set of optimal allocations of assets for a portfolio. The method comprises obtaining a user's investment profile, obtaining an integer constraint on the total number of assets to include in the portfolio, and generating a set of optimal allocations of assets using portfolio optimization. The optimal allocations reflect the user's investment profile and contain the total number of assets limited by the integer constraint.

In accordance with the invention, the portfolio optimization process may be constrained so that only portfolios which contain a user-acceptable number of assets are obtained. Users may also identify optimal and near-optimal portfolios which are within user acceptable tolerances and preferences. Investors may choose to display any of these optimal and near-optimal portfolios as part of their portfolio balancing process. Investors may advantageously reduce asset turnover and decrease service costs associated with portfolio rebalancing, as well as retain particularly desired assets in their portfolios, while increasing returns without taking on significant risks.

The invention may be hosted by a service provider who maintains the method and systems of the invention, updates the information stored in memory, or provides the physical or computer facilities or space for its use by an interested party. The service provider would also periodically update the data utilized by the invention to ensure that the portfolios generated by the invention reflect recent market and financial conditions and are not outdated. A service provider may be a single entity or a plurality of entities providing services to a user.

The present invention also provides a data processing system for electronically generating over an electronic network a set of optimal or near optimal portfolios which reflect the user's investment profile and which contain the number of assets corresponding to an integer constraint. The data processing system may comprise a server and a client, wherein the client enables the user to interface with the invention.

The present invention also provides a computer readable media for controlling a computer over an electronic network to generate an optimal or near-optimal allocation of assets in a portfolio. The portfolio corresponds to the user's investment profile, which may have incorporated a constraint on the number of assets to include in the portfolio.

The present invention also provides for an optimal or near-optimal portfolio of assets generated over an electronic network, wherein the portfolio is generated by a method incorporating a constraint on the number of assets to include in the optimal or near-optimal portfolio.

### BRIEF DESCRIPTION OF THE DRAWINGS

FIG. 1 illustrates a hardware diagram of an exemplary embodiment of a system according to the present invention.

FIG. 2 is a flow diagram showing an operational flow from the user's perspective of a method or system according to an exemplary embodiment of the present invention.

FIG. 3 is a flow diagram showing a process for selecting recommended and alternative portfolios for display to the user according to an exemplary embodiment of the present invention.

FIG. 4 illustrates the distribution of constrained and unconstrained efficient frontiers in an exemplary embodiment of the present invention.

FIG. 5 is an expanded view of a portion of FIG. 4 and shows the identification of recommended portfolios, alternative portfolios, and non-recommended portfolios in an embodiment of the present invention.

FIG. 6 is a flow diagram showing a process of calculating a factor covariance matrix of an exemplary embodiment of the present invention.

FIG. 7 is a flow diagram showing a process of using a genetics algorithm to generate a near-optimal portfolio in an exemplary embodiment of the current invention.

### DETAILED DESCRIPTION

The present invention provides a system and method to assist users in developing optimal and near-optimal portfolios of assets in accordance with the user's investment profile by including an integer constraint on the number of assets to include in the portfolio. Those skilled in the art will understand that the present invention can be utilized to develop, balance, or rebalance portfolios comprising any type of financial asset, such as, but not limited to, equity, debt, or mortgage-backed securities. For example, stocks, bonds, mutual funds, derivatives, Treasury bills, commodities or currency may be successfully used to create optimal and near-optimal portfolios.

In this invention, a near-optimal portfolio is to be considered as an allocation of assets which is within the user's acceptable tolerances of an optimal portfolio. For example, if an optimal portfolio consisting of eight mutual funds has a risk of 0.64% and an expected return of 0.76%, a near-optimal portfolio acceptable to the user may include eleven funds and have a risk and expected return of 0.64-0.70% and 0.70-0.77%, respectively. Acceptable tolerances may be different for each investor and may comprise features such as a portfolio's expected return and risk.

The features of the invention will be described in reference to the embodiments described in the Figures. The embodiments described in this invention are intended to be merely exemplary and not limiting in any way. Numerous variations and modifications of the present invention will be readily apparent to those skilled in the art. All such variations and modifications are intended to be within the scope of the current invention as defined in the attached claims.

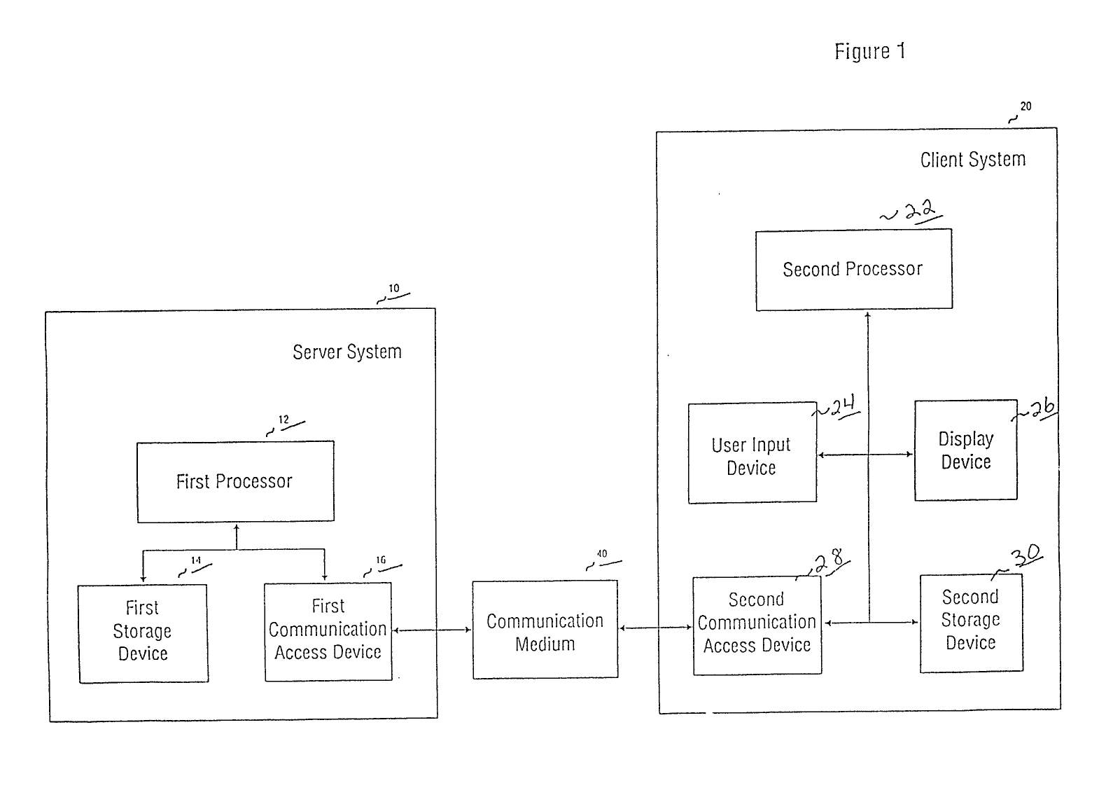

FIG. 1 is a hardware diagram of an embodiment of a system according to the present invention. The system comprises a server component 10 and a client component 20. The server 10 comprises a first processor 12, a first storage device 14, and a first communications access device 16. The client system 20 comprises a second processor 22, a user input device 24, a display device 26, a second communications access device 28, and a second storage device 30. The client communications access device 28 and the server communications access device 16 are connected via a communications medium 40, referred to as a network.

The server system 10 may comprise a conventional remote computer or local server running conventional software applications enabling the server to provide server functions to a plurality of clients. These functions may include processes such as serving applications or providing access to data. Although FIG. 1 only shows a single client system 20 and a single server system 10, those knowledgeable in the art will appreciate that a plurality of clients 20 may be served by a server 10, and that a plurality of servers 10 may be utilized to process the information that is sent to a client 20.

The client system 20 may be a conventional computer system or electronic device, such as an IBM™-compatible, Macintosh™ or Unix™-based personal computer, a telephone capable of displaying and sending information, or a personal information manager such as a Palm™ handheld computer device, as well as a dumb client terminal in communication with a main computer. A user may access the invention through a client system.

The first and second processors 12 and 22 may be any type of machine language programs which accept a source program written in a symbolic form and which translate the source program into an object program acceptable to the machine for which the source code was written. Examples of processor manufacturers are Intel™, AMD™, Motorola™, and IBM™. The processors 12 and 22 may also control the retrieval, decoding and processing of information, as well as the interpretation and execution of operating instructions. These instructions may comprise arithmetic, logic, and control elements.

The client input device 24 may include devices such as a keyboard, mouse, voice-dictation apparatus, handwriting tablet, keypad, or touch screen. The client display device 26 may include devices such as a computer monitor, LCD screen, television, or telephone handset digital or LCD display. Displayed data may also be printed out in a personalized report format for a user. Experienced practitioners will understand that various types of information displays are common in many electronic systems and that many types of displays are possible within the scope of this invention.

Users may have distinct preferences for the format in which data is presented on the client display device 26. Depending on the type of information presented, certain individuals prefer a streamlined text-based display while other users will prefer a graphical display with charts and figures. An embodiment of the invention provides the option for a user to select text-based, graphical, or other types of displays on the client display device 26.

Context-sensitive “help” or additional, detailed information about a particular asset can be displayed on the client display device 26 upon a specific user input request. As an example, when a user clicks a mouse button upon an appropriate section of the display, help can appear in a window to provide additional information about a feature of the invention or the portfolio currently being displayed.

The first and second storage devices 14 and 30 may include conventional devices such as memory, hard drives, optical drives, and CD-ROM drives for providing data storage, warehousing, and retrieval capabilities. Data may be stored on the devices 14 and 30 in a form accessible by a database such as Corel Paradox™, IBM DB2™ or Oracle Database 8i™. The first and second communications access devices 16 and 28 may include conventional devices such as a modem, network interface card or port, or wireless transmitter for providing computer-to-computer communication capabilities.

The client system 20 may also be loaded with generally-available web browsing programs such as Netscape Navigator™ and Microsoft Internet Explorer™, image viewing programs such as Adobe Acrobat™, presentation programs such as Corel Presentations™, and analysis tools including spreadsheets such as Lotus 1-2-3™ and Microsoft Excel™. Visually impaired users may choose a program such as In Cube™ or IBM HomePageReader™ to provide access to the invention.

Information in the invention is transmitted between a client 20 and a server 10 via the communications access devices 16 and 28 over the communications medium or network 40, which may be wireless or wire-lined. Examples of electronic networks that are effective in transmitting information and data are local-area networks, wide-area networks, intranets, and the Internet. Depending on the particular type of network implemented in the invention, electronic protocols such as TCP/IP, NetBEUI, Ethernet, or PPP may be effectively used by networking products such as Novell NetWare™ or Lotus Notes Network™.

The instruction set that is used to direct a system 10 or 20 to perform a function in the invention may be present as software in memory or implemented as hardware, for example by being burned onto a computer chip or integrated circuit, and may be hosted by one or both of the client 20 and the server 10. The instruction set may be written in C++, VisualBasic™, assembler, Borland Delphi™, Java™, Javascript™, or any other language or combination of languages selected by a service provider, coder or programmer. The instruction set may also be a macro or template in a spreadsheet, or a custom-designed and implemented application. A service provider may also choose to implement the invention as an applet within a web page.

The invention may be hosted by a service provider on a publicly-accessible site, location, or web page, or on a restricted-access site. A user may, for example, access the software by running a web browser on a client system 20 and entering a uniform resource locator (“URL”) corresponding to the web address of a server system 10. The server system 10 may be running a web server which then allows access to the software application. Those skilled in the art will appreciate that there are many combinations of electronic systems and instruction sets that may be effectively used in the present invention.

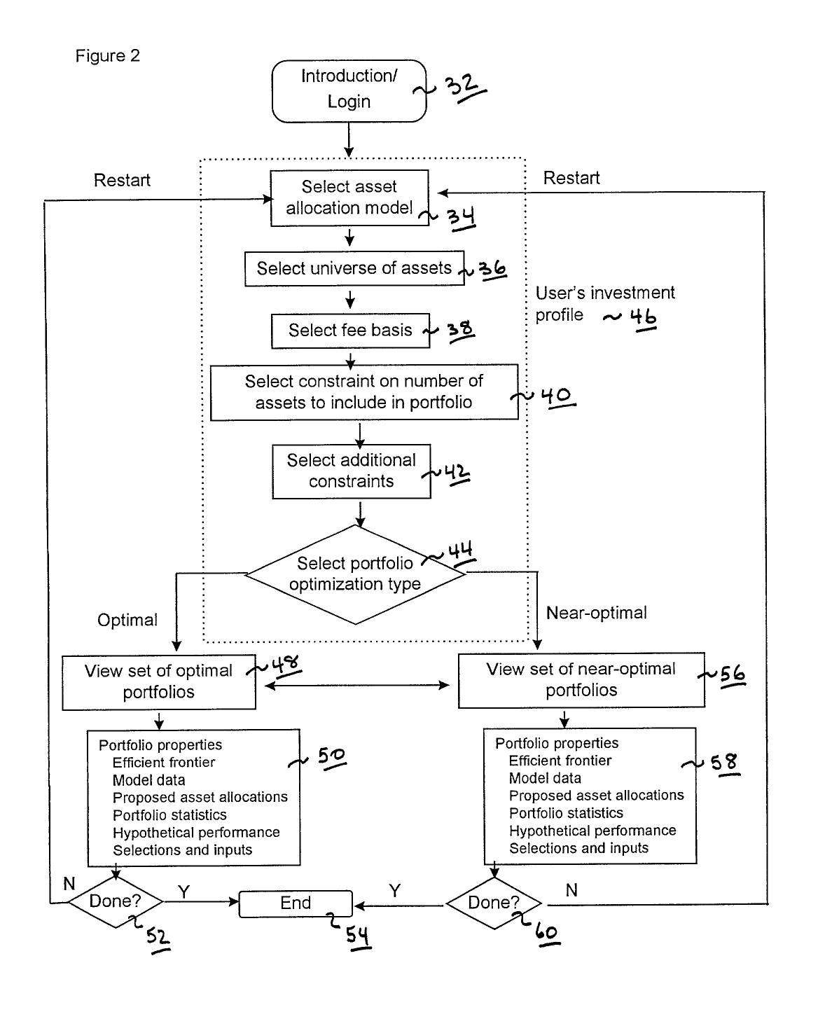

An operational flow diagram for generating a provider-recommended optimal or near-optimal portfolio from the perspective of the user, wherein the number of assets in the portfolio is limited by an integer constraint, is depicted in the embodiment of FIG. 2. As part of a portfolio optimization process, a service provider may require that the user first log into a client system 20 (not shown in this Figure) supporting the invention using a login procedure 32. The login process 32 may comprise a user's entering a username and password prior to accessing the client system 20. A username and password input by a user may then be compared to an authentication database located on a storage medium to verify the user's eligibility to use the invention. The purpose of the login procedure 32 may be to control user access to the invention, for example, to separate user accounts, to retrieve each individual user's investment profile, historical portfolios, and account information, or to prevent one user from accessing, modifying, or tampering with another user's account. The login 32 may also be used to provide identifying information for billing purposes, for example if the service provider charges a fee for use of the invention. Those skilled in the art will understand that there are many login procedures that may be employed in the present invention.

In conjunction with, or as an alternative to, a login procedure, the service provider may choose to provide to a user an introductory presentation in 32. The service provider may customize this introductory presentation in 32 for many purposes. For example, an introduction in 32 may include a presentation of related products available to the user by the service provider, or the introduction in 32 may comprise a presentation of advertisements. The service provider may choose to instruct the user on the advantages of the invention in portfolio design, or to display to the user service information such as network load or the number of concurrent users.

After login 32, a user may commence to input the user's investment profile 46, which shall be understood to mean any settings or inputs which will customize the output of the invention in accordance to the user's inputs. An input comprising the investment profile 46 may be entered by the user, by the service provider, or by a combination of both. A service provider may choose to provide default settings for each input, which may be overridden by a user. The specific nature of each of the inputs may vary depending on the specific embodiment of the invention implemented by a service provider. Several possible inputs comprising a user's investment profile will now be described in reference to the embodiment of the invention shown in FIG. 2.

As an element of his or her investment profile, a user may select an asset allocation category, strategy, or model in 34. A service provider may choose to create several categories of asset allocation models which represent similar users'investment goals. A user would then select a model in 34 which he or she feels best identifies his or her investment goals from the list of models provided. Instead of providing a list of asset allocation models, the service provider may alternatively furnish the user with a questionnaire in 34 which will identify a particular asset allocation model that may be the most appropriate for the user.

The service provider may implement the invention in such a manner that the selection of an asset allocation category in 34 incorporates all the default constraints necessary to design a portfolio, enabling the user to avoid having to enter any additional inputs. The asset allocation categories in 34 may also provide model asset class allocations for the optimization. The optimization would then be constrained so that the portfolios generated in accordance with the invention would have the same or similar asset class allocation recommendation as the model selected in 34.

An example of five such asset allocation models used by financial institutions and investment houses such as Merrill Lynch & Co. are: Capital Preservation, Current Income, Income and Growth, Long-Term Growth, and Aggressive Growth. These models or investment types and their risk categories, relative risk and expected returns are shown in Table 1. It will be understood that these models are merely groupings which conveniently categorize similar investors'financial strategies, and that different service providers may categorize investors in a different manner or include alternative modes of identifying investment goals.

TABLE 1
Examples of asset allocation models

| Investment Type | | | Expected |
|---|---|---|---|
| Asset Allocation Model | Risk Category | Relative Risk | Return |
| Capital Preservation | Conservative | minimal | low |
| Current Income | Conservative to | ↓ | ↓ |
| | moderate | | |
| Income and Growth | Moderate | | |
| Long-Term Growth | Moderate to | | |
| | aggressive | | |
| Aggressive Growth | Aggressive | high | high |

Another element comprising the user's investment profile 46 may be the type of assets or asset classes to be included in the portfolio. The user may have an option to select the universe of assets or asset classes in 36 from which to create a portfolio. The universe in 36 may comprise only one asset class, such as mutual funds or small-cap stocks, or it may comprise a plurality of assets or asset classes, such as stocks, bonds, mutual funds, Treasury notes, and other assets. The universe of assets or the asset classes in 36 may be selected by the user, by the service provider, or by both.

In an embodiment of the invention, a service provider or a user may choose to restrict the universe of assets in 36 to a certain class or number of assets. For example, a service provider may preselect the universe of assets for a near-optimization to include only assets which perform in the top 40% of their category, such as the top 40% highest yielding corporate bonds. The elimination of the lower-performing 60% of the assets from the universe should ensure that only the highest-quality assets are being utilized in the proposed asset allocation, and that lower-quality assets, e.g. with lower returns or higher risks, will not dilute or reduce the performance of the portfolio. Alternatively, a service provider may wish to restrict the universe of assets available to an investor to only its own financial instruments. For example, the user may select to include only Merrill Lynch securities such as Merrill Lynch stock and Merrill Lynch mutual funds in the universe in 36, to the exclusion of all non-Merrill Lynch financial instruments. In such a case, a service provider may advantageously benefit from a recommendation of its own proprietary assets in a client's optimal or near-optimal portfolio through the exclusion of assets offered by non-affiliated financial institutions.

A user may also be provided the option to select a fee basis in 38, that is, to select whether to restrict the universe of assets to fee-based assets or non-fee-based assets, or to include both types of assets in the universe. In an embodiment of the present invention, users may have an opportunity to eliminate any direct costs associated with the use of the invention by selecting fee-based portfolio management in 38. In such an implementation, no direct fees would be charged to a user by a service provider for use of the invention in portfolio optimization, although other fees such as an asset management fee may be charged for administration of the assets in the user's portfolio. In another embodiment, a user may select a non-fee basis in 38 and costs associated with the use of the invention in portfolio optimization would be recovered by the service provider in another manner.

Another element comprising a user's investment profile may be a constraint on the number of assets in 40 that are included in an optimal or near-optimal portfolio. For example, a user may constrain the optimization to include at least five assets but no more than seven assets. A user may also restrict the portfolio to only a given number of assets, such as five mutual funds or seven stocks and bonds. The constraints in 40 on the number of assets to include in the portfolio may be provided by a user, by a service provider, or by both.

A service provider may implement additional constraints in 42 which would further describe a user's investment profile. These additional constraints in 42 would serve to further customize the outputs of the invention to match the user's preferences. For example, in an embodiment of the invention, additional elements which may comprise a user's investment profile may include an upper or lower boundary on the number of assets in the portfolio, an upper or lower boundary on the percent composition that may be allocated to an asset in a portfolio, or an upper or lower boundary on the value that may be allocated to an asset in a portfolio. In a further embodiment, a user's investment profile may comprise additional elements such as an upper or lower boundary on the number of asset classes in a portfolio, an upper or lower boundary on the percent composition that may be allocated to an asset class, an upper or lower boundary on the value that may be allocated to an asset class, or an upper or lower boundary on the value of an asset in an asset class. A user may also have the ability to display additional information about model data or research data that will be used in generating a portfolio of assets.

Additional elements in 42 which may comprise the user's investment profile 46 include the investor's tolerances of features such as risk and expected return about an optimal portfolio. These tolerances may be used during identification of near-optimal portfolios or during identification of recommended portfolios from a constrained efficient frontier. For example, a user may input a risk tolerance of 0.05% about the optimal. If the risk of an optimal portfolio is 0.70%, the risk range of an acceptable near-optimal portfolio would be 0.70%±0.05%=0.65% to 0.75%. A user may also input an expected return tolerance to additionally define the output of the invention. When the optimal return of a portfolio is 1.0%, an expected return tolerance of 0.1% indicates that an allocation of assets may have a range of expected returns from 0.9% to 1.1%. These inputs in 42 may be entered by the user or by the service provider, or may be incorporated as part of an asset allocation model previously selected by the user in 34.

An additional element included in the user's investment profile 46 may be the selection in 44 of a portfolio optimization type, that is, an optimization or a near-optimization. A user may constrain the optimization procedure 44 to identify only an optimal portfolio, or only a near-optimal portfolio, or to generate both optimal and near-optimal portfolios concurrently.

Once the system has obtained the user's investment profile 46 comprising the inputs in 34-44 necessary to generate a desired optimal or near-optimal portfolio, the system would then use the inputted profile 46 to generate a set of recommended optimal or near-optimal portfolios for the user. The system may also generate a set of alternative optimal or near-optimal portfolios should the user wish to view one or more additional optimal or near-optimal portfolios. The system may also generate and display a set of unconstrained optimal portfolios for the user, to enable the user to review the effects that the constraints may have on a portfolio through comparison of constrained and unconstrained portfolios. The generated set of optimal portfolios incorporating the constraints of the user's investment profile will form a constrained efficient frontier.

After the system has generated a set of optimal or near-optimal portfolios that correspond to the user's investment profile 46, the user may then view a resultant recommended portfolio in 48 or a recommended near-optimal portfolio in 56, and obtain further information on the properties of the recommended portfolio in 50 or 58. These properties of a displayed optimal portfolio in 50 or near-optimal portfolio in 58 may include any item that would enable the user to better understand the portfolio. Examples of properties that may be displayed in 50 and 58 include the proposed asset allocations, model asset class allocation data, asset class factors, portfolio statistics, portfolio hypothetical performance and returns, the efficient frontier, the user's historical portfolio allocations, the portfolio's expected return, portfolio risk, and the user's selections and inputs. Depending on the nature of the assets in a portfolio, certain features of a portfolio in 50 and 58 may be more appropriate, relevant, or of interest to the investor than other features. The list of portfolio properties in 50 and 58 is intended to be merely exemplary and not limiting in any way.

In another embodiment of the invention, a user may have an option to subsequently display a portfolio of another type, for example, to display a near-optimal portfolio in 56 if an optimal portfolio in 44 was initially selected, or an optimal portfolio in 48 if a near-optimal portfolio was selected in 44. A user may also be able to display alternative portfolios of the same type, that is, the user may be able to display one or more alternative near-optimal portfolios in addition to the set of recommended portfolios. The display of alternative portfolios may occur upon an appropriate user input or command, such as touching a touch-sensitive display panel or clicking a mouse upon a button in the display window.

In an additional embodiment of this invention, a user may be given the option to display a plurality of portfolios or portfolio features concurrently. An investor may wish to view both optimal and near-optimal portfolios on the same display, or to view the position of a portfolio on a constrained, unconstrained, or model frontier. By viewing a plurality of allocations or portfolio properties concurrently, a user can determine how the selected portfolios compare with each other.

After the user has completed viewing a proposed asset allocation or any property of an asset allocation in 50 and/or 58, the user may then select in 52 or 60 to end the current session with the invention in 54, or to restart the portfolio optimization process from 34 or any other point using different inputs. The user may also have the opportunity of moving “back” to a previous input step in the invention at any time, for example, to modify previous inputs. Moving back to a previous step may be accomplished by an appropriate action of the input device, such as a mouse click or touching a “back” button on a display panel or keyboard.

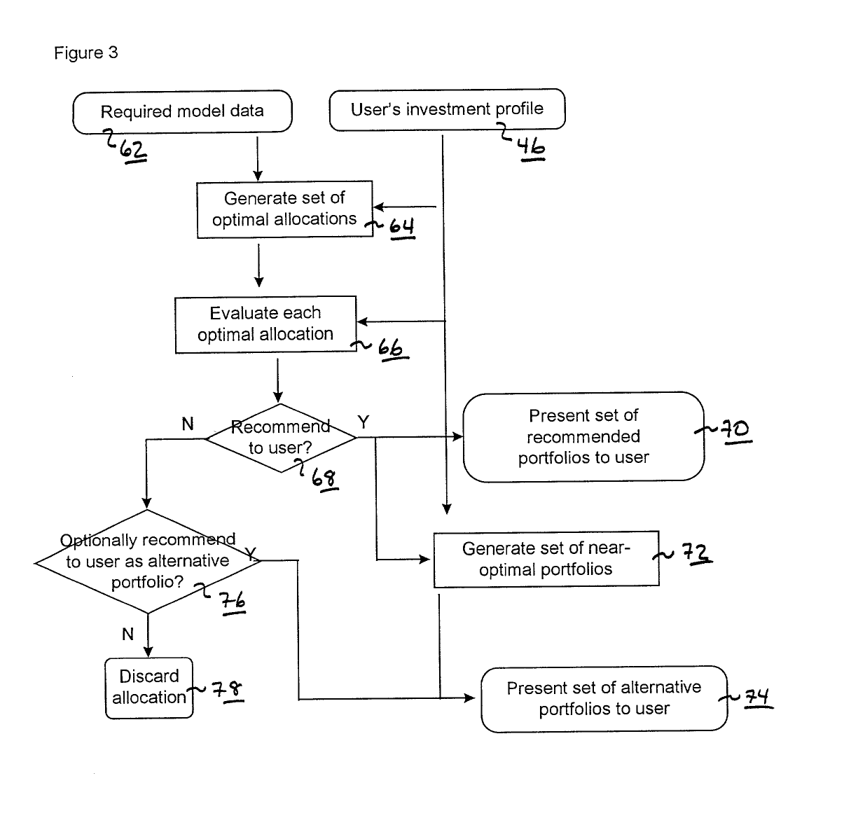

FIG. 3 is a flow diagram showing a process for selecting recommended and alternative optimal portfolios for display to the user according to an exemplary embodiment of the present invention. In this embodiment, in a previous step not shown, the user will have already customized his or her investment profile to generate an optimal portfolio in accordance with a particular asset allocation model such as Current Income. As can be seen in FIG. 3, the portfolios that may be recommended to the user will consist of two types, recommended portfolios in 70, and alternative portfolios in 74.

The recommended portfolios in 70 consist of a set of optimal portfolios which are considered by the service provider to be the most suitable allocations of assets for the investor. These optimal portfolios generated using the constraints in the user's investment profile lie closest to the unconstrained efficient frontier. Upon user selection to display a set of optimal allocations in 44, this set of recommended portfolios will be the allocations presented to the user in 70 and 48.

The set of alternative portfolios in 74 consists of a set of allocations on the constrained efficient frontier which are further away from the unconstrained efficient frontier than the recommended portfolios in 70, and therefore, these alternative portfolios are not considered to be the most preferred portfolios. Nevertheless, the alternative portfolios in 74 are acceptable allocations in view of the user's investment profile 46 and therefore may still be displayed to the user, although not as prominently as the recommended portfolios. The set of optionally recommended portfolios in 74 may also comprise a set of near-optimal allocations, generated in 72 from the recommended portfolios using the method described in this invention.

The user's investment profile 46 may be obtained using a process such as that described in the embodiment of FIG. 2. The required model data 62 may comprise elements such as historical risk and expected returns of the assets or asset classes in the universe previously selected by the user in 36, and any other additional data necessary for the system to generate an optimal or near-optimal portfolio.

In the embodiment of FIG. 3, an initial set of constrained optimal allocations is generated in 64 based upon the user's investment profile 46 and any additional model data 62 that may be required. This set of allocations in 64 may be considered as representing a constrained efficient frontier of the universe of assets selected by the user as part of the user's investment profile 46. The set of constrained optimal allocations (the constrained efficient frontier) will have taken into account the user's preferences, such as the number of assets to include in a portfolio. In addition to the constrained optimal allocations 64, an unconstrained efficient frontier is generated in concert with the identification of recommended and alternative portfolios.

After the constrained efficient frontier and the unconstrained efficient frontier are generated in 64, for example using a form of mean-variance optimization, each constrained allocation is then evaluated in 66 in view of the user's investment profile 46 and the unconstrained efficient frontier to identify in 68 whether the allocation will be recommended and presented to the user in 70. One or more allocations on the constrained efficient frontier which lie closest to the unconstrained efficient frontier may be selected as part of a set of recommended portfolios to the user. For example, a constrained optimal allocation which has the same or similar risk and expected return as an allocation on the unconstrained efficient frontier, may be selected for inclusion in the set of recommended portfolios which will be displayed to the user in 70.

If an allocation on the constrained frontier is not sufficiently close to the unconstrained frontier to be a recommended portfolio and therefore does not pass 68, the allocation may still be acceptable within the tolerances specified in the user's investment profile 46. In this circumstance, the allocation may be considered in 76 to be one of a set of alternative, or optionally recommended, portfolios. An alternative portfolio may be presented to the user in 74 in a subsequent display panel, for example if the user selects a button entitled “Display Alternative Portfolios” on the client display device 26. The user may also be able to switch back and forth between recommended and alternative portfolios displayed on the client display device 26.

As part of a set of alternative portfolios to the user, the service provider may also generate in 72 a set of near-optimal allocations of assets derived from the recommended portfolios identified in 68. These near-optimal portfolios would be generated in view of the user's investment profile 46 according to this embodiment of the present invention.

If an allocation of assets on the constrained frontier does not pass 76, the allocation is deemed to lie too far from the unconstrained efficient frontier, and the allocation will not be recommended to the user, either as a recommended portfolio in 70 or as an alternative portfolio in 74. The properties of the allocation, such as its risk or expected return, are so far removed from the user's investment profile that another allocation would provide a more suitable investment vehicle for the user. Therefore, the unsuitable allocation will not be presented to the investor in 76, and is removed from further consideration in 78.

Although the embodiment of FIG. 3 describes the generation and selection of recommended and alternative optimal portfolios, the experienced practitioner will readily understand how to modify the embodiment to generate recommended and alternative near-optimal portfolios.

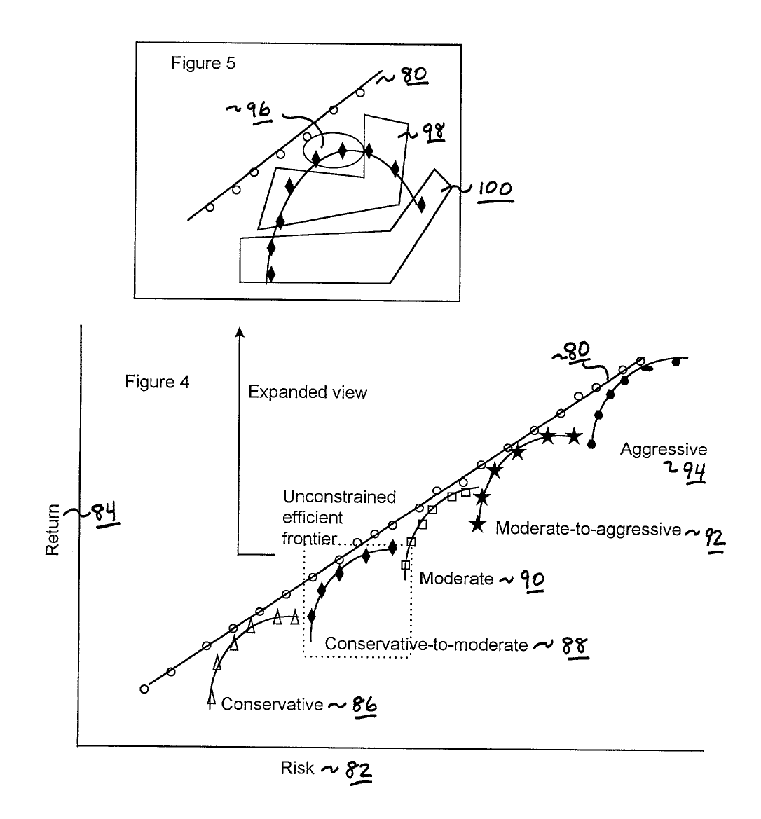

FIG. 4 illustrates the relationship of constrained and unconstrained efficient frontiers in an embodiment of the present invention. The x-axis 82 in FIG. 4 corresponds to the risk of a portfolio and the y-axis 84 represents the expected return of a portfolio.

The unconstrained efficient frontier 80 indicates a set of portfolios for which the expected returns of the assets are maximized for a particular risk level. In this embodiment, the unconstrained efficient frontier 80 is found using mean-variance optimization. A constrained efficient frontier such as 86, 88, 90, 92, or 94 may be identified using the method described in this invention. This constrained efficient frontier in 86, 88, 90, 92, or 94 would correspond to the asset allocation model selected by the user in 34 as part of the user's investment profile 46. The allocations of assets in the asset classes of a constrained optimal portfolio would reflect the user's desired allocations. An allocation located on the constrained efficient frontier will have been generated with a constraint on the number of assets to include in the portfolio.

Although a plurality of constrained frontiers is displayed in FIG. 4 to demonstrate the distribution of the constrained and unconstrained frontiers, in this embodiment only one constrained frontier would customarily be generated, the constrained frontier corresponding to the allocation model selected by the user as part of the user's investment profile. For example, an investor who has selected a Current Income asset allocation model in 34 would only be shown portfolios generated according to this selected model, and portfolios obtained using another asset allocation model such as Aggressive Growth, would not be generated and therefore not displayed. However, a service provider may choose to generate and concurrently display portfolios generated using a plurality of asset allocation models. In general, a constraint placed on the portfolio optimization process, such as a limitation on the number of assets in the portfolio, will generate portfolios with lower returns than will an optimization without such constraints. Hence, a constrained efficient frontier, e.g. 86, 88, 90, 92, or 94, will generally be found below the unconstrained efficient frontier 80.

FIG. 5 is an expanded view of a portion of FIG. 4 and shows the identification of recommended optimal portfolios 96, alternative optimal portfolios 98, and non-recommended portfolios 100 from the constrained efficient frontier 88 in an embodiment of the present invention. The unconstrained efficient frontier 80 represents a set of optimal allocations with the highest return for a given level of risk, without having been constrained by a limitation on the number of assets. The optimal allocations comprising the constrained efficient frontier 88 would have been generated with the constraint that they contain a particular number of assets 40 and other elements comprising the user's investment profile 46.

Recommended optimal portfolios in 96 would be those on the constrained efficient frontier 88 which are closest to the unconstrained efficient frontier 80. These recommended portfolios 96 are identical to those of 70 in FIG. 3, and are the allocations which would provide the user with the highest returns for a particular asset allocation model given the user's investment profile 46. The acceptable distance of constrained optimal portfolios from the unconstrained efficient frontier may be set by the user or by the service provider during entry of the user's investment profile 46.

Portfolios on the constrained efficient frontier 88 which have lower returns or higher risk than the recommended returns, but which are still acceptable according to the user's investment profile 46, may be categorized as alternative portfolios 98. These portfolios are optimal allocations with expected returns and/or risk levels less desirable than those of the recommended portfolios, and comprise the set of alternative recommendations of 74 in FIG. 3.

Portfolios on the constrained frontier 88 which are significantly distant from the unconstrained efficient frontier 80 will be considered as a set of non-recommended portfolios 100. The risks and/or returns of these allocations 100 are outside the acceptable tolerances indicated by the user during entry of the user's investment profile 46. These allocations 100 would typically not be presented to the user, having been discarded in 78 from further consideration.

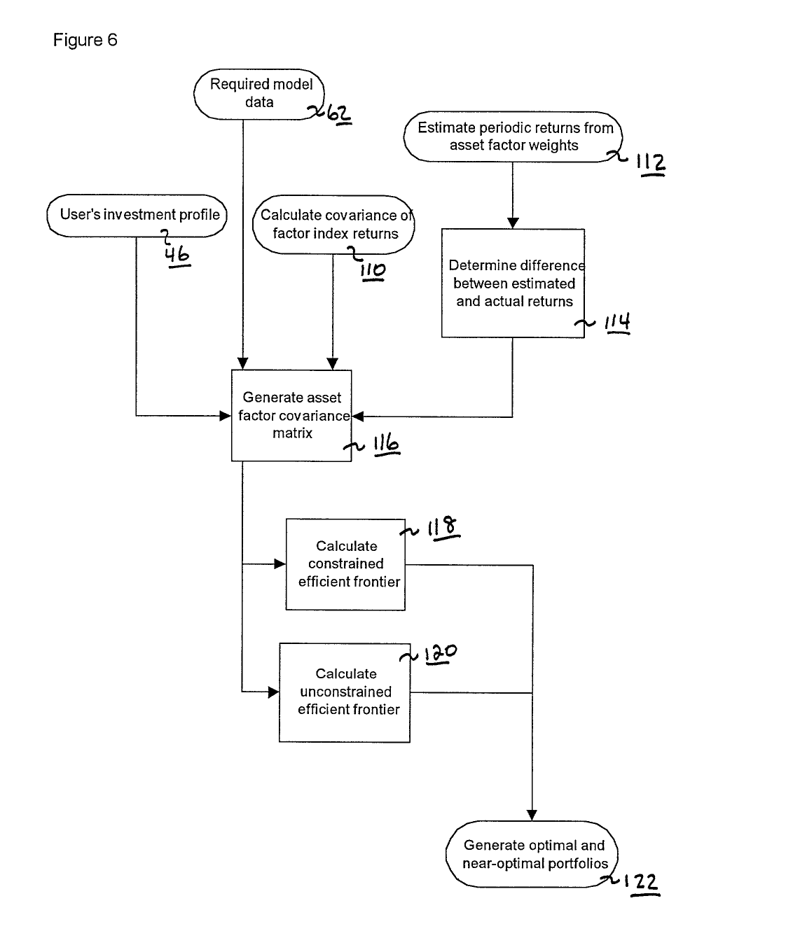

A brief discussion of asset class factor analysis (hereafter termed “factor analysis”) will be provided prior to a discussion of the implementation of factor analysis in the embodiment of the present invention shown in FIG. 6. Through statistical analysis of an asset's total returns and comparisons to multiple asset classes as represented by market indexes, factor analysis (sometimes termed asset class style analysis) seeks to explain the performance of an asset as a composite of its underlying asset classes.

In an embodiment of the current invention, the risks and returns of asset class factors are used to determine asset allocations rather than the risks and returns of the assets themselves. Each asset is decomposed into one or more asset classes in order to adequately account for the variation in asset returns in any given period that can be attributed to the combined effects of these asset classes and the realized returns of those classes.

FIG. 6 shows a flowchart depicting a process of generating an asset factor covariance matrix used in a mean-variance optimization embodiment of the present invention. When the user employs the present invention to generate portfolio recommendations, properties such as risk and expected return of asset classes comprised by an asset are used during the generation of one or more near-optimal allocations, rather than the actual assets. This process will be described with reference to the equations below.

In this embodiment of the invention, a mean-variance optimization is enhanced to include asset class factors. An overall efficient frontier for N number of assets may be constructed by solving a standard quadratic programming problem that determines the weight wᵢ for each asset to minimize the variance for a given return R. The covariance matrix in this case is based on the underlying L asset class factors. The equations used to describe this problem can be written as follows:

$$\begin{matrix}mi n i m i z e {σ}_{p}^{2} = {\sum }_{i = 1}^{N} W [ {SFS}^{- 1} + NF ] & ( 1 ) \\ s ub j e c t t o : {\sum }_{i = 1}^{n} {w}_{i} = 1 & ( 2 )\end{matrix}$$

where W=vector of asset weights=[w₁w₂ . . . w_{N}]

$$where S = style matrix = [ \begin{matrix}{S}_{11} & {S}_{12} & ⋯ & {S}_{1 L} \\ {S}_{21} & {S}_{22} & ⋯ & {S}_{2 L} \\ ⋮ & ⋮ & & ⋮ \\ {S}_{N1} & {S}_{N2} & ⋯ & {S}_{N L}\end{matrix} ]$$

where Sᵢⱼ=style weight of asset i in asset factor j

$$F = covariance matrix using asset factor indexes = [ \begin{matrix}{f}_{11} & {f}_{12} & ⋯ & {f}_{1 L} \\ {f}_{21} & {f}_{22} & ⋯ & {f}_{2 L} \\ ⋮ & ⋮ & & ⋮ \\ {f}_{L1} & {f}_{L2} & ⋯ & {f}_{L L}\end{matrix} ]$$

where f₁=covariance of asset factor i to asset factor j

$$NF = matrix of non \text{-} factor variance = [ \begin{matrix}{nf}_{1} & O & ⋯ & O \\ O & {nf}_{2} & ⋯ & O \\ ⋮ & ⋮ & & ⋮ \\ O & O & ⋯ & {nf}_{N}\end{matrix} ]$$

NF is an error term for each asset which accounts for the asset's specific return that could not be explained by the factor analysis.

The constraint of equation (3) is designed to prevent short positions of assets in these portfolios. That is, assets must have a positive or zero percentage of the portfolio, and negative percentages representing short positions are prevented. The presence of the inequality in equation (3) requires the use of a mathematical programming algorithm in solving the matrix problem.

To control the number of assets that enter a portfolio, additional binary integer variables may be introduced to the constraint set. The sum of these variables, shown in equations (4) and (5), must lie within the range of minimum and maximum assets specified for the portfolio.

$$MINF UNDS \leq {\sum }_{i = 1}^{n} {inout}_{i} \leq MAXFUNDS \qquad ( 5 )$$

In conventional mean-variance analysis, there is no pre-determined limit on the number of assets that may comprise a portfolio. The typical requirement that an asset comprise between zero and 100% of a portfolio (0≦wᵢ≦100%) imposes a mathematical programming solution.

In this embodiment of the invention, the constraint on the number of assets to include in a portfolio requires significant modification of the solving process in the mean-variance model. The restriction that a portfolio include a given number of assets requires that the normally quadratic equation used in a classic mean-value analysis include coefficients that must be discrete integers and not continuous variables. This directive changes the quadratic problem into a mixed integer non-linear programming problem. Mixed integer nonlinear programming problems are among the most difficult optimization problems of all.

The particular asset class indexes that are utilized in the factor-based covariance matrix may be commonly available, such as the Dow Jones™ Industrial Average or the Russell 2000™ index of 2000 small-cap stocks. The indexes may also be proprietary to the service provider. The asset classes themselves may also be defined as desired by the service provider. For example, the asset class “stocks” may be available to the user as a single group of assets, or the general category may be defined at the discretion of the service provider as a number of subclasses such as large cap growth stocks, large cap value stocks, small cap growth stocks, small cap value stocks, regional, continental, or global stocks. Cash is typically not included in a portfolio as currency. Rather, the cash component of a portfolio is held in the form of short-term, liquid assets such as Treasury bills or money market accounts.

To adequately account for the effect that a composite asset, such as a mutual fund, may have on the portfolio, the asset may be subdivided into its component asset classes. For example, a mutual fund may be composed of large cap growth stocks, large cap value stocks, small cap growth stocks, small cap value stocks, international stocks, fixed income securities, and cash. If a composite asset is not decomposed into its component asset classes, the optimization process may not adequately take into account the plurality of asset classes present in the composite asset. In such a case, the resultant portfolios may not have the particular asset class distribution desired by the investor.

A portfolio comprising several different asset classes (large and small cap growth stocks, large and small cap value stocks, international stocks, fixed-income securities, and cash) can be described using equations (6)-(12) below. A service provider may choose to consolidate a plurality of asset classes into a larger group, for example by combining all types of stock, whether large cap, small cap, value, growth, international, or other categories, into one broader asset class. The service provider may also introduce other assets or asset classes, or create narrower asset classes, depending upon the universe of assets made available by the service provider and selected by the user. By modifying the appropriate constraints, a portfolio of any asset composition may be devised from the universe of assets.

$$\begin{matrix}Min ( LCG ) \leq {\sum }_{i = 1}^{N} {w}_{i} {LCG}_{i} \leq Max ( LCG ) & ( 6 ) \\ Min ( LCV ) \leq {\sum }_{i = 1}^{N} {w}_{i} {LCV}_{i} \leq Max ( LCV ) & ( 7 ) \\ Min ( SCG ) \leq {\sum }_{i = 1}^{N} {w}_{i} {SCG}_{i} \leq Max ( SCG ) & ( 8 ) \\ Min ( SCV ) \leq {\sum }_{i = 1}^{N} {w}_{i} {SCV}_{i} \leq Max ( SCV ) & ( 9 ) \\ Min ( INTEQ ) \leq {\sum }_{i = 1}^{N} {w}_{i} {INTEQ}_{i} \leq Max ( INTEQ ) & ( 10 ) \\ Min ( FI ) \leq {\sum }_{i = 1}^{N} {w}_{i} {FI}_{i} \leq Max ( FI ) & ( 11 ) \\ Min ( CASH ) \leq {\sum }_{i = 1}^{N} {w}_{i} {CASH}_{i} \leq Max ( CASH ) & ( 12 )\end{matrix}$$

where:

LCGᵢ=proportion of asset i composed of large cap growth stocks;

LCVᵢ=proportion of asset i composed of large cap value stocks;

SCG₁=proportion of asset i composed of small cap growth stocks;

SCVᵢ=proportion of asset i composed of small cap value stocks;

INTEQᵢ=proportion of asset i composed of international stocks;

FI₁=proportion of asset i composed of fixed income securities;

CASH₁=proportion of asset i composed of cash equivalents;

where

LCGᵢ+LCVᵢ+SCGᵢ+SCVᵢ+INTEQᵢ+FIᵢ+CASHᵢ=1

In addition to the overall unconstrained efficient frontier, e.g. 80, constrained frontiers may be constructed for different levels of risk tolerance. For example, five sub-frontiers, e.g. 86, 88, 90, 92, and 94, may be generated for each of the asset allocation models previously mentioned in Table 1 (Capital Preservation, Current Income, Income and Growth, Long-Term Growth and Aggressive Growth) by adding constraints to rebalance the proportion of the various size and style asset classes. A relatively conservative risk category such as Capital Preservation may be comprised of mostly Treasury securities as an asset class, while a more aggressive allocation model may comprise small cap value and growth stocks as a major holding. A constrained optimal portfolio may be identified for each of the asset allocation models in addition to the unconstrained overall efficient frontier. As previously stated, the efficient frontiers of the five asset allocation models described above generally fall below the overall unconstrained efficient frontier due to the additional constraints imposed by the risk and expected returns of the model.

FIG. 6 shows a flowchart depicting a process of generating an asset factor covariance matrix in 116, the matrix being used in a mean-variance optimization embodiment of the present invention. The user's investment profile 46, previously described in FIG. 2, is used in conjunction with required model data 62 to generate the matrix in 116. The required model data 62 may comprise items such as asset factor weights, asset returns, and asset index returns. The user's investment profile 46 may comprise settings and user preferences on the number, type, and fee basis of the assets to include in the optimization.

Additional inputs needed by the covariance matrix in 116 include the covariance of the factor index returns 110 and the difference in 114 between estimated and actual asset returns. The difference in 114 between the estimated and the actual periodic returns is taken as the residual variances not explained by the factor indexes. This difference in 114 is in turn obtained from an estimate 112 of periodic returns from asset factor weights. The periodic returns may be based on any convenient time period such as monthly or semimonthly.

Once the system has available the appropriate inputs and model data, the system then prepares to calculate the asset factor covariance matrix in 116 to be used in a mean-variance optimization. After the matrix in 116 is obtained by the system, the constrained and unconstrained efficient frontiers in 118 and 120 may be calculated. The unconstrained efficient frontier in 120 may be generated using a suitable mean-variance method, and an appropriate calculation method such as quadratic programming may be used to solve the algorithm in the unconstrained approach.

The constrained efficient frontier in 118 is more difficult to identify because of the integer constraint on the number of assets to include in the portfolio. In this invention, a novel mixed-integer nonlinear programming approach is used to solve for the constrained efficient frontier in 118. Although the service provider may choose to generate an efficient frontier using any of several approaches, one particularly effective method is to solve for portfolios ranging from minimum covariance (lowest risk) to maximum return (highest risk).

Once the system has calculated the constrained and unconstrained efficient frontiers in 118 and 120, the optimal and near-optimal allocations are generated in 122 according to the present invention. Recommended and alternative portfolios may be displayed to the user. The portfolios in 122 will have included the asset class distribution requested by the user during entry of the user's investment profile.

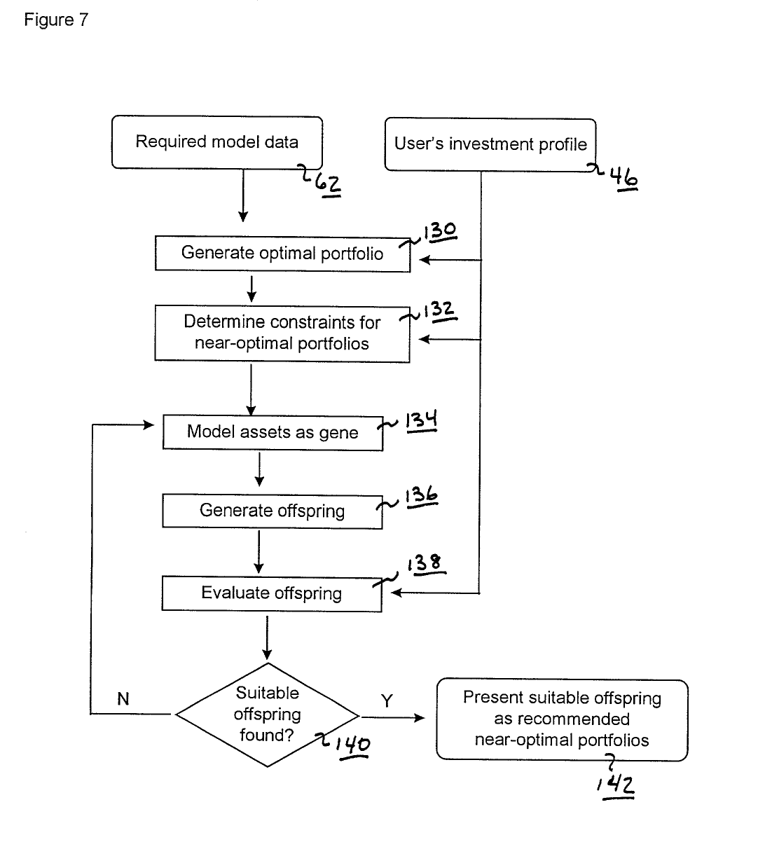

A general discussion of genetics algorithms will now be provided prior to discussion of the implementation of the algorithm in the current invention, an embodiment of which is shown in FIG. 7. A genetics algorithm is essentially a software version of the evolutionary process that occurs in nature. This is done by the creation, within a machine, of a population of individuals represented by chromosomes, in essence mimicking the DNA-based reproduction process seen in living organisms. A major advantage of an electronic implementation of a genetics algorithm over the biological process is that the electronic implementation is unquestionably faster and many more generations can be obtained in a short period of time. Crossover, mutation and tournament selection (“survival of the fittest”) are important operations that maintain the diversity of the population as well as allow the algorithm to sample large stretches of possible solutions.

Genetics algorithms are used for a number of application areas, such as design of robot trajectories, strategy planning, design of neural networks, optimization, and sequence scheduling. The algorithm does not by itself “solve” a given problem. Rather, the algorithm creates sets of possible solutions to the problem. In conjunction with a fitness or evaluation function which assesses the potential solutions, a best solution is ultimately generated and identified.

A typical genetics algorithm is implemented in a manner similar to the following cycle:

(a) initialize a population of individuals;

(b) evaluate the fitness of the individuals in the population using tournament selection;

(c) select a sub-population for offspring reproduction;

(d) recombine the “genes”of selected parents via crossover, mutation, or other operations to generate a new population of individuals; and

(e) discard the old population and evaluate the fitness of the new population.

A genetics algorithm is typically used to generate the “best” answer to a problem. However, in the present invention, the genetics algorithm is not implemented to locate an optimal allocation of assets. Rather, the function of the genetics algorithm is to generate a plurality of allocations through mutations, crossovers, and tournament selection, and to provide these allocations to the fitness function. The genetics algorithm merely generates sets of allocations of assets derived from the optimal portfolio and therefore potential near-optimal solutions.

In the present invention, new “candidate” near-optimal allocations of assets are generated from an optimal portfolio using operations such as crossover and mutation (termed the generation operations) in conjunction with the tournament selection operation of the genetics algorithm. The allocations may be termed “candidate allocations” as it is unknown before evaluation by the fitness function whether or not these portfolios will be acceptable near-optimal portfolios or merely non-optimal allocations. After generation, the candidate allocations are subsequently evaluated by the fitness function to determine whether any allocations fall within the user's investment profile. Thus, each portfolio is merely a particular combination of assets written using a digital string of computer code.

In an embodiment of the invention, the fitness function of the genetics algorithm is the risk associated with the allocation of assets; the risk of a portfolio of assets is minimized while attempting to maximize returns within the user's investment profile. Candidate allocations whose risk or expected returns are outside the user's acceptable tolerance are removed from future consideration, as these allocations are unacceptably distant from an optimal portfolio. Allocations which are within user-acceptable tolerance for risk and expected return are potential near-optimal portfolios and are retained for use in offspring generation via crossover and mutation. After multiple iterations of the generation and tournament selection operations, a set of allocations will be identified which are within user acceptable tolerance for properties such as risk and expected return. These allocations, which are not optimal but yet are acceptable according to the user's investment profile, would be considered to comprise a set of near-optimal portfolios.

The genetics algorithm generates numerous candidate portfolios or “individuals” of the “population”. Each individual or “strand” or “chromosome” is comprised of a given number of “genes”, each gene representing one particular asset e.g. cash, 15-year Treasury bond, Merrill Lynch preferred stock, etc. The number of genes in an individual or an individual strand corresponds to the total number of assets that are available for inclusion in the portfolio. For example, an individual chromosome strand of one hundred genes indicates that one hundred different assets are available for inclusion in the portfolio. The constraints on the number and type of assets to include in a portfolio will have been previously input as a component of the user's investment profile.

To recognize that certain assets may be considered as a set of asset classes, the chromosome strands that are generated in each iteration may be broken down into their underlying asset classes, and the combination of these asset classes may be evaluated to determine the entire strand's (portfolio's) risk and expected return levels. Each asset class is weighted to enable the chromosome or portfolio to reflect the user's asset distribution preferences in the investment profile. Chromosomes whose combination of asset class allocations have the best combination of low risk and high return are retained as the parent chromosome strand of a generation, and then “mated” with another chromosome, starting the process anew. The mating may also comprise crossover of genes among a plurality of chromosome strands.

A simple example will illustrate the use of a genetics algorithm in the current invention. A chromosome representing a portfolio with four possible assets can be written as A-B-C-D, each letter representing a separate asset allocation. Upon mutation, one or more random genes in the strand is replaced by another gene representing another asset allocation. In the present example, if a single mutation occurs to chromosome A-B-C-D wherein an existing gene is replaced by a new gene “J”, four mutated chromosomes are possible. As seen in Table 2, these chromosomes may be written as J-B-C-D, A-J-C-D, A-B-J-D, and A-B-C-J, signifying that the first, second, third, and fourth genes, respectively, in each chromosome were replaced by the new gene “J”.

If mutated chromosome J-B-C-D mates with a new chromosome depicted as W-X-Y-Z, two new strands obtained from a crossover operation could be written as J-B-Y-Z and W-X-C-D, wherein crossover occurred in the center of each strand. Similarly, if chromosome A-B-C-J mates with W-X-Y-Z, two resultant portfolios may be A-B-Y-Z and W-X-C-J. Several chromosomes which may be obtained from crossover and mutation of parent chromosome A-B-C-D are shown in Table 2. In Table 2, the chromosomes have crossed over in the centers of each strand, although crossover can occur at any position of a strand. As can be readily observed, when two chromosomes mate, new strands are formed and the original strands no longer exist.

TABLE 2
Example of chromosomes generated via crossover and mutation.

| | | |
|---|---|---|
| Original | Original chromosome | Mutated chromosomes after |
| chromosome | after mutation | crossover with W-X-Y-Z |

| | | | |
|---|---|---|---|
| A-B-C-D | J-B-C-D | J-B-Y-Z | W-X-C-D |
| | A-J-C-D | A-J-Y-Z | W-X-C-D |
| | A-B-J-D | A-B-Y-Z | W-X-J-D |
| | A-B-C-J | A-B-Y-Z | W-X-C-J |

The fitness function of the algorithm in the present invention is taken as the portfolio risk. When an allocation's risk is at or below the user's risk tolerance, returns are at or above the user's minimum acceptable return, and the allocation of assets and asset classes in the portfolio is within the outlines of the model, a near-optimal portfolio is obtained. A chromosome strand is kept if it is feasible and the portfolio it represents meets the user's investment profile. For example, if the sum of the asset allocations of a portfolio does not equal 100%, the chromosome is considered non-feasible and therefore will be removed from further consideration.

Each of the candidate near-optimal allocations obtained from the genetics algorithm discussed above is considered as a potentially viable near-optimal asset allocation. The user will be interested in all solutions which are within an acceptable risk/return tolerance range, where the risk value for each of the near-optimal portfolios is acceptably close to the optimal, and the expected return is near the optimal value for the portfolio.

FIG. 7 is a flowchart which depicts a detailed process of generating a near-optimal portfolio using a genetics algorithm in an embodiment of the present invention. An optimal portfolio of assets is identified in 130 from the universe of assets available to the investor based on his or her investment profile 46 and any additional required model data 62. Based on the user's investment profile 46, constraints for near-optimal portfolios such as the user's tolerance of risk and expected return about the optimal may be identified in 132.

Once the constraints are identified in 132, the operations comprising the genetics algorithm begin. In 134, each candidate asset in an optimal portfolio is modeled as a gene of a chromosome, the chromosome being the entire universe of assets available to the user. From the chromosome, a plurality of offspring are generated in 136 using the operations of the genetics algorithm such as crossover and mutation. Each newly-generated offspring portfolio is evaluated in 138 by comparison to the user's investment profile 46. Offspring which are near the optimal result within the user-acceptable constraints 132 and are acceptable according to the user's investment profile 46, are retained as near-optimal portfolios. If there are no suitable near-optimal portfolios found in 140 in this generation of the algorithm, the routine moves back to a previous step to create another generation of offspring for evaluation. Eventually in 140, one or more near-optimal portfolios acceptable to the user are identified. These portfolios may then be presented to the user as a set of recommended portfolios in 142. The pattern of breeding and discard of subpar allocations may be considered a form of natural selection of the fittest allocation for the investor.

In generating one or more near-optimal allocations in 136, the algorithm may perform multiple passes during optimization, for example starting with a portfolio with the lowest known risk and returns and maximizing the return, and then starting with a portfolio with the highest known risk and returns and minimizing the risk. Ultimately, the portfolios which are recommended to the user in 142 are the most fit, that is, that have the highest returns for the investor's maximum risk tolerance.

The determination of optimal and near-optimal portfolios in the present invention can be performed in advance, by presolving the algorithm, or in real time. In real-time analysis, the service provider employs the user's inputs on the client system to generate a set of appropriate optimal or near-optimal portfolios over the network. After such a set of portfolios is identified, it may then be presented to the user.

In presolving, the portfolio analysis for various combinations of inputs and for different user investment profiles has been previously solved by the service provider. Upon entry of the user's investment profile, the system selects an appropriate investment portfolio for display to the user, which may involve lookup from a database or data table. Certain service providers may wish to combine presolving and real-time analysis approaches in an embodiment of the invention.

Some users are anticipated to employ this invention in multiple instances to examine or rebalance their portfolios. Without some means of storing information, users may experience duplication of effort through periodic re-entering of data into the system, for example by re-entering the user's investment profile every time the user wishes to rebalance a portfolio. One embodiment of the present invention includes the ability to store a user's settings and investment profile, and the invention's outputs in memory. Examples of features that can be stored for each user are current and past holdings, financial goals, risk level and investment strategy. The login procedure 32 can be used to distinguish among a plurality of users and only return information specific to a particular user.

In an additional embodiment of the invention, a computer readable media may be used for controlling a computer to generate over an electronic network a portfolio of optimal or near-optimal allocations, where the number of assets in the portfolio is limited by an integer constraint. Such an implementation may include an instruction set physically located on a type of storage medium such as a floppy disk, read-only compact disk, installed on a user's or service provider's hard disk or other storage device, or transmitted via a local or wide area network such as the Internet. The data that is utilized in the analysis may be retained in memory in a spreadsheet, database, data table, or any other type of electronic record storage, either on the local system or accessible via a network. It will be obvious that there should be periodic updates of the model and financial data required by the invention in order for the portfolios generated to reflect the most recent market conditions. Those skilled in the art will understand there are many implementations of instruction sets in the current invention that are possible.

In another embodiment of the invention, an electronic network may be used to generate an optimal or near-optimal portfolio, the portfolio containing the total number of assets limited by an integer constraint. The network is used to connect a client system and a server system, and may be wirelined or wireless. A rapid protocol may be used by the network to transmit data between a client system and a server system to reduce time spent by the user waiting for data to be loaded and displayed by the client.

In another embodiment of the invention, an optimal or near-optimal portfolio of assets may be generated over an electronic network. The portfolio is generated by a method comprising obtaining a user's investment profile, obtaining an integer constraint on the number of assets to include in the portfolio, and generating a set of optimal or near-optimal allocations reflecting the user's investment profile. The portfolio contains the number of assets limited by the integer constraint.

Numerous modifications and variations of the present invention are possible in light of the above teachings, and therefore, within the scope of the appended claims, the invention may be practiced otherwise than as particularly described.

What is claimed is:

1. A method for electronically generating over a network a set of near-optimal allocations of assets for a portfolio, said method comprising:
a. obtaining a user's investment profile;
b. obtaining a set of optimal allocations of assets using portfolio optimization; and
c. generating a set of near-optimal allocations of assets derived from the optimal allocations by a genetics algorithm, wherein the near-optimal allocations reflect the user's investment profile.

2. A method for electronically generating over a network a set of near-optimal allocations of assets for a portfolio, said method comprising:
a. obtaining a user's investment profile;
b. obtaining an integer constraint on the total number of assets to include in the portfolio;
c. obtaining a set of optimal allocations of assets using portfolio optimization, said optimal allocations reflecting the user's investment profile; and
d. generating a set of near-optimal portfolios derived from the set of optimal allocations by a genetics algorithm, wherein the near-optimal portfolios reflect the user's investment profile and contain the total number of assets limited by the integer constraint.

3. A method for electronically generating over a network a set of optimal allocations of assets for a portfolio, said method comprising:
a. obtaining a user's investment profile;
b. obtaining an integer constraint on the total number of assets to include in the portfolio; and
c. generating a set of optimal allocations of assets using portfolio optimization, said optimal allocations reflecting the user's investment profile and containing the total number of assets limited by the integer constraint.

4. The method according to any one of claim 1 or 2, wherein the genetics algorithm comprises at least one of the following operations selected from the group consisting of crossover, mutation, and tournament selection.

5. The method according to any one of claim 1, 2, or 3, wherein the portfolio optimization comprises mean-variance optimization.

6. The method according to any one of claim 1, 2, or 3, wherein the user's investment profile is prepared by the user, the service provider, or both.

7. The method according to any one of claim 1, 2, or 3, comprising the ability to restrict the assets selected for inclusion in the portfolio to a set preselected by the user, the service provider, or both.

8. The method according to any one of claim 1, 2, or 3, comprising the ability to restrict the asset class factors selected for inclusion in the portfolio to a set preselected by the user, the service provider, or both.

9. The method according to any one of claim 1, 2, or 3, wherein the assets are selected from the group consisting of fee-based assets, non-fee based assets, and combinations thereof.

10. The method according to any one of claim 1, 2, or 3, wherein the asset allocations are electronically obtained by at least one technique selected from the group consisting of presolving, lookup, and calculation in real-time.

11. The method according to any one of claim 1, 2, or 3, comprising the option for the user to display detailed information selected from the group consisting of an allocation of assets and model data.

12. The method according to any one of claim 1, 2, or 3, comprising the option to retain inputs and asset allocations in memory between sessions.

13. The method according to any one of claim 1, 2, or 3, wherein at least one of the following constraints is specified and is selected from the group consisting of: an upper boundary on the number of assets held in the portfolio, a lower boundary on the number of assets held in the portfolio, an upper limit on the percentage composition allocated to an asset in the portfolio, a lower boundary on the percentage composition allocated to an asset in the portfolio, an upper limit on the value allocated to an asset in the portfolio, and a lower limit on the value allocated to an asset in the portfolio.

14. The method according to any one of claim 1, 2, or 3, wherein at least one of the following constraints on the portfolio is specified and is selected from the group consisting of: an upper boundary on the number of asset class factors held, a lower boundary on the number of asset class factors held, an upper limit on the percentage composition allocated to an asset class factor, a lower boundary on the percentage composition allocated to an asset class factor, an upper limit on the value allocated to an asset class factor, and a lower limit on the value allocated to an asset class factor.

15. The method according to any one of claim 1, 2, or 3, wherein a constraint is specified by the user, the service provider, or both.

16. The method according to claim 5, wherein the mean-variance optimization is solved by a mixed-integer nonlinear programming technique.

17. The method according to claim 5, wherein the optimal portfolios are obtained by asset class style covariance during the mean-variance optimization.

18. A method for obtaining a near-optimal allocation of assets over an electronic network, the method comprising the steps of:
a. inputting a user's investment profile into a client system connected to a network;
b. providing the user's investment profile to a processor;
c. generating in said processor a set of optimal allocations of assets based on the user's investment profile using portfolio optimization; and
d. generating a set of near-optimal allocations of assets derived from the optimal allocations by a genetics algorithm, wherein the near-optimal allocations reflect the user's investment profile.

19. A method for obtaining an optimal allocation of assets in a portfolio over an electronic network, the method comprising the steps of:
a. inputting into a client system connected to a network a user's investment profile and an integer constraint on the total number of assets to include in a portfolio;
b. providing to a processor the user's investment profile and the integer constraint on the total number of assets to include in the portfolio; and
c. generating in said processor a set of optimal allocations of assets based on the user's investment profile and containing the number of assets limited by the integer constraint.

20. A method for obtaining a near-optimal allocation of assets in a portfolio over an electronic network, the method comprising the steps of:
a. inputting into a client system connected to a network a user's investment profile and an integer constraint on the total number of assets to include in a portfolio;
b. providing to a processor the user's investment profile and the total number of assets to include in the portfolio; and
c. generating in said processor a set of near-optimal allocations of assets based on the user's investment profile and containing the total number of assets limited by the integer constraint.

21. A data processing system for electronically generating a near-optimal allocation of assets for a portfolio over an electronic network, said system comprising:
a. a means for obtaining a user's investment profile;
b. a means for obtaining a set of optimal allocations of assets using portfolio optimization; and
c. a means for generating a set of subsequent near-optimal allocations of assets derived from the optimal allocations by a genetics algorithm, wherein the near-optimal allocations reflect the user's investment profile.

22. A data processing system for electronically generating an optimal allocation of assets for a portfolio over an electronic network, said system comprising:
a. a means for obtaining a user's investment profile;
b. a means for obtaining an integer constraint on the number of assets to include in a portfolio; and
c. a means for obtaining a set of optimal allocations of assets using portfolio optimization, wherein the optimal allocations reflect the user's investment profile and contain the total number of assets limited by the integer constraint.

23. A data processing system for electronically generating a near-optimal allocation of assets for a portfolio over an electronic network, said system comprising:
a. a means for obtaining a user's investment profile;
b. a means for obtaining an integer constraint on the number of assets to include in a portfolio; and
c. a means for obtaining a set of near-optimal allocations of assets using portfolio optimization, wherein the near-optimal allocations reflect the user's investment profile and contain the total number of assets limited by the integer constraint

24. A data processing system comprising a client and a server for generating a near-optimal allocation of assets for a portfolio over a network, said client comprising:
a1. a processor for carrying out the operations of the client system;
a2. a storage device for storing a user's investment profile;
a3. a display device for soliciting information from a user and for displaying outputs to the user;
a4. an input device for permitting the user to interact with the system; and
a5. a communication access device for transmitting to and receiving information from an electronic network;
said server comprising:
b1. a processor for generating a set of optimal allocations of assets corresponding to the user's investment profile using portfolio optimization, and for generating a set of near-optimal allocation of assets derived from the optimal allocations using a genetics algorithm;
b2. a storage device for storage and retrieval of inputs and outputs; and
b3. a communications access device for transmitting to and receiving information from the network.

25. A data processing system comprising a client and a server for generating over an electronic network an optimal allocation of assets for a portfolio, said client comprising:
a1. a processor for carrying out the operations of the client system;
a2. a storage device for storing a user's investment profile;
a3. a display device for soliciting information from a user and for displaying outputs to the user;
a4. an input device for permitting the user to interact with the system; and
a5. a communication access device for transmitting to and receiving information from an electronic network;
said server comprising:
b1. a processor for obtaining an integer constraint on the number of assets to include in the portfolio, and for using portfolio optimization to generate a set of optimal allocations of assets corresponding to the user's investment profile;
b2. a storage device for storage and retrieval of inputs and outputs; and
b3. a communications access device for transmitting to and receiving information from the network.

26. A data processing system comprising a client and a server for generating over an electronic network a near-optimal allocation of assets for a portfolio, said client comprising:
a1. a processor for carrying out the operations of the client system;
a2. a storage device for storing a user's investment profile;
a3. a display device for soliciting information from a user and for displaying outputs to the user;
a4. an input device for permitting the user to interact with the system; and
a5. a communications access device for transmitting to and receiving information from an electronic network;
said server comprising:
b1. a processor for obtaining an integer constraint on the number of assets to include in a portfolio, and for generating a set of near-optimal allocations of assets corresponding to the user's investment profile;
b2. a storage device for storage and retrieval of inputs and outputs; and
b3. a communications access device for transmitting to and receiving information from the network.

27. A computer readable media for controlling a computer to generate over an electronic network a near-optimal allocation of assets in a portfolio using portfolio optimization, said computer to perform the steps of:
a. obtaining a user's investment profile;
b. obtaining a set of optimal allocations of assets using portfolio optimization; and
c. generating a set of subsequent near-optimal allocations of assets derived from the optimal allocations by a genetics algorithm, wherein the near-optimal allocations reflect the user's investment profile.

28. A computer readable media for controlling a computer to generate over an electronic network an optimal allocation of assets in a portfolio, said computer to perform the steps of:
a. obtaining a user's investment profile;
b. obtaining an integer constraint on the total number of assets to include in a portfolio; and
c. generating a set of optimal portfolios, said optimal allocations reflecting the user's investment profile and containing the number of assets limited by the integer constraint.

29. A computer readable media for controlling a computer to generate over an electronic network a near-optimal allocation of assets in a portfolio, said computer to perform the steps of:
a. obtaining a user's investment profile;
b. obtaining an integer constraint on the total number of assets to include in a portfolio; and
c. generating a set of near-optimal portfolios, said near-optimal portfolios reflecting the user's investment profile and containing the number of assets limited by the integer constraint.

30. A near-optimal portfolio of assets generated over an electronic network, said portfolio generated by a method comprising:
a. obtaining a user's investment profile;
b. obtaining a set of optimal allocations of assets by portfolio optimization; and
c. generating a set of subsequent near-optimal allocations of assets derived from the optimal allocations by a genetics algorithm, wherein the near-optimal allocations reflect the user's investment profile.

31. An optimal portfolio of assets generated over an electronic network, said portfolio generated by a method comprising:
a. obtaining a user's investment profile;
b. obtaining an integer constraint on the total number of assets to include in a portfolio; and
c. generating a set of optimal allocations of assets, said optimal allocations reflecting the user's investment profile and containing the total number of assets limited by the integer constraint.

32. A near-optimal portfolio of assets generated over an electronic network, said portfolio generated by a method comprising:
a. obtaining a user's investment profile;
b. obtaining an integer constraint on the total number of assets to include in a portfolio; and
c. generating a set of near-optimal allocations of assets, said near-optimal allocations reflecting the user's investment profile and containing the total number of assets limited by the integer constraint.
